(19) United States
(12) Patent Application Publication
(10) Pub. No.: US 2026/0158904 A1
(43) Pub. Date: Jun. 11, 2026

(54) TANK DEVICE WITH LEAKAGE MONITORING

(71) Applicant: MAGNA Energy Storage Systems GesmbH, Sinabelkirchen (AT)

(72) Inventor: Michael BINDER, Gleisdorf (AT)

(73) Assignee: MAGNA Energy Storage Systems GesmbH, Sinabelkirchen (AT)

(21) Appl. No.: 19/179,444

(22) Filed: Apr. 15, 2025

(30) Foreign Application Priority Data
May 21, 2024 (EP) 24176963.7

(51) Int. Cl. B60K 15/04; B60K 15/03; B60K 15/05; G01M 3/32

(52) U.S. Cl. CPC B60K 15/0406; B60K 15/05; G01M 3/3272; B60K 2015/0321; B60K 2015/0451

(57) ABSTRACT

A tank apparatus for a motor vehicle includes a tank having a filling nozzle for filling the tank, a vacuum leak detection unit (VLD), and a tank closure for placement on the filling nozzle between an unclosed position and a closed position. The VLD unit is configured to identify inadequate leak-tightness of the tank by monitoring a reduced pressure in the tank. The tank closure includes a sealing element which forms a seal with respect to the filling nozzle when the tank closure is in the closed position. The tank closure further includes a spacing element which engages the filling nozzle when the tank closure is in the unclosed position to thereby prevent contact of the sealing element with the filling nozzle.

### CROSS-REFERENCE TO RELATED APPLICATIONS

The present disclosure claims priority under 35 U.S.C. § 119 to European Patent Publication No. EP 24176963.7 (filed on May 21, 2024), which is hereby incorporated by reference in its complete entirety.

### TECHNICAL FIELD

The present disclosure relates to a tank apparatus for a motor vehicle.

### BACKGROUND

Tank apparatuses are known to be used in motor vehicles in order, for example, in a tank in the motor vehicle to guide the fuel required for driving the motor vehicle, for example, petrol or diesel for an internal combustion engine as a drive motor.

Tank systems are already known which use a VLD Unit (Vacuum Leak Detection or Diagnosis), for example, a Natural Vacuum Leak Detection (NVLD) Unit in order to use the reduced pressure which is generally produced when the fuel cools, for example, when the vehicle is stopped, in the tank in order to identify a non-leak-tightness of the tank, consequently a leak.

For example, German Patent Publication No. DE 10 2012 212 109 A1 discloses a tank ventilation system of a motor vehicle which is provided with an internal combustion engine which comprises an NVLD unit having a membrane valve unit via which the tank system which contains an intermediate store which can be cleaned via a cleaning line which opens in the intake channel of the internal combustion engine for volatile hydrocarbons discharged from the tank is checked for adequate leak-tightness after the vehicle has been parked by a formation of reduced pressure in the tank system which is blocked in an appropriate manner with respect to the environment being monitored, wherein there is provided a bypass line which bridges or bypasses the NVLD unit with the blocking valve which is provided therein between the tank system and the environment, via which bypass line ambient air can reach the intermediate store with an open blocking valve which is in a closed position in an appropriately controlled manner when the vehicle is parked and is at least open during a cleaning operation of the intermediate store.

When a tank closure, for example, after a tank has been filled, is only placed on the filling nozzle of a tank, but is not or is not correctly in a closed position, there is an incorrect situation which should also be identified by the tank system. However, a tank closure which has been placed in this manner is often not identified as a leak by a VLD unit.

### SUMMARY

An object of the present disclosure is to provide a tank apparatus for a motor vehicle which can identify a tank closure which has only been put in place and which is not in a closed position.

The object is achieved by a tank apparatus for a motor vehicle comprising a tank having a filling nozzle for filling the tank and a tank closure which can be placed on the filling nozzle and can be in a closed position on the filling nozzle, wherein the tank apparatus comprises a VLD unit (Vacuum Leak Detection) which is configured to identify inadequate leak-tightness of the tank by monitoring a reduced pressure in the tank, wherein the tank closure comprises a sealing element which, when a tank closure is in a closed position on the filling nozzle, seals with respect to the filling nozzle, wherein the tank closure comprises a spacing element which, when a tank closure is placed on the filling nozzle and is not in a closed position, bears on the filling nozzle and thereby prevents contact of the sealing element with the filling nozzle so that there is no leak-tightness between the tank closure and filling nozzle.

As a result of the fact that the sealing element of the tank closure which is not in a closed position has no contact with the filling nozzle, the tank closure is not drawn against the filling nozzle via a reduced pressure being produced in the tank and the leakage is identified by the VLD unit.

In accordance with the present disclosure, it has been determined that the reduced pressure which is produced in a tank is often sufficient to pull a tank closure which has been placed but not correctly in a closed position against the filling nozzle of the tank so that a VLD unit detects an anticipated reduced pressure and does not identify any non-leak-tightness.

In accordance with the present disclosure, a tank closure is therefore provided with at least one spacing element, in particular at least one resilient element which, when a tank closure has been placed on the filling nozzle and not in a closed position, bears on the filling nozzle and thereby prevents contact of the sealing element with the filling nozzle. The spacing element preferably prevents the sealing element from moving axially closer to the filling nozzle. The tank closure is then not drawn against the filling nozzle by a reduced pressure in the tank and the non-leak-tightness can be identified by the VLD unit, for example, an NVLD unit.

Should the tank closure be in a closed position on the filling nozzle, the at least one spacing element is made ineffective by the closure, in particular screwing, in particular the position of the spacing element is displaced so that, when a tank closure is in a closed position on the filling nozzle, the sealing element seals against the filling nozzle.

Preferably, the spacing element is a resilient element, against the force of which, when the tank closure is in a closed position on the filling nozzle, the sealing element is brought into contact with the filling nozzle.

Preferably, the tank closure and/or the filling nozzle has a thread so that the tank closure can be in a closed position on the filling nozzle by being screwed.

The spacing element, preferably resilient element, may be formed from spring sheet steel.

Preferably, the tank closure comprises a plurality of spacing elements, preferably resilient elements, which, when the tank closure has been placed, are arranged circumferentially around the opening of the filling nozzle on the tank closure, that is to say at least two spacing elements.

A single spacing element may, for example, extend at least partially in the circumferential direction of the opening of the filling nozzle.

A spacing element may protrude from the tank closure in the direction towards the filling nozzle.

A spacing element may with respect to the opening of the filling nozzle have a curvature or bend radially outwards which, when the tank closure axially approaches a formation, in particular shoulder, of the filling nozzle in the direction towards the filling nozzle, brings about a movement of the spacing element radially outwards.

The spacing element preferably bears, when a tank closure is placed on the filling nozzle and is not in a closed position, on the filling nozzle on a shoulder of the filling nozzle in such a manner that the spacing element when the tank closure is in a closed position is pressed radially outwards with respect to the opening of the filling nozzle so that the sealing element comes into contact with the filling nozzle and seals with respect to the filling nozzle.

Preferably, the sealing element is an annular seal which, when the tank closure is placed, extends around the opening of the filling nozzle.

Preferably, the tank apparatus comprises with the exception of the sealing element no additional sealing element which seals between the tank closure and the filling nozzle.

Should the tank apparatus comprise at least one additional sealing element, each additional sealing element which, when a tank closure is in a closed position on the filling nozzle, seals with respect to the filling nozzle, when a tank closure is placed on the filling nozzle and is not in a closed position is arranged in such a manner that the additional sealing element does not seal between the tank closure and the filling nozzle so that there is no leak-tightness between the tank closure and filling nozzle.

Further developments of the present disclosure are set out in the dependent claims, the description and the appended drawings.

### DRAWINGS

The present disclosure will be described by way of example below with reference to the drawings.

FIG. 1 illustrates a cut-out sectioned view of a tank apparatus for a motor vehicle that includes the position of a region A.

FIG. 2 illustrates a sectioned view of a related art (i.e., not in accordance with the present disclosure) tank apparatus with the tank closure not placed in a closed position.

FIG. 3 illustrates a sectioned view of a tank apparatus in accordance with the present disclosure, with the tank closure not placed in a closed position.

FIG. 4 illustrates a sectioned view of a tank apparatus in accordance with the present disclosure, with the tank closure placed in a closed position.

### DESCRIPTION

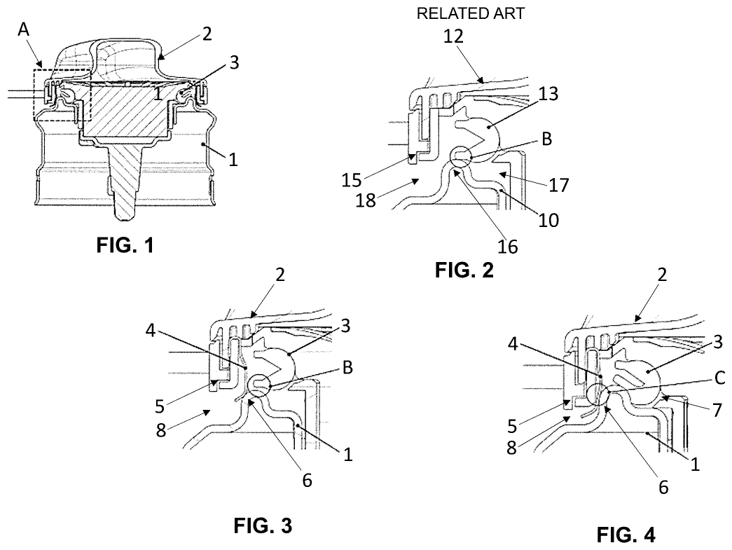

FIG. 1 illustrates a sectioned view of a tank apparatus for a motor vehicle in, which shows the filling nozzle 1 of a tank which is otherwise not illustrated in greater detail. The filling nozzle 1 is closed via a tank closure 2. A sealing element 3 which extends around the circumference of the filling nozzle 1 acts between the tank closure 2 and the filling nozzle 1. The region A which is illustrated in FIG. 1 as a dashed rectangle is illustrated in detail in FIGS. 2 through 4.

In this instance, FIG. 2 shows a related art tank apparatus with the tank closure 12 not placed in a closed position. The tank closure 12 comprises a circumferential sealing element 13. The sealing element 13 rests in the illustrated region B on a shoulder 16 of the filling nozzle 10. The tank apparatus lacks any spacing element or resilient element which would prevent the sealing element 13 from resting on the shoulder 16 when the tank closure is not in a closed position. When a reduced pressure 17 occurs in the tank, that is to say, a reduced pressure in comparison with the ambient pressure 18, the sealing element 13 is therefore drawn inwards in the direction towards the filling nozzle 1 and consequently the support thereof on the filling nozzle 10 is further reinforced. An NVLD unit (not illustrated) consequently identifies an anticipated reduced pressure and consequently no problem in the tank system.

In contrast, FIG. 3 shows a tank apparatus in accordance with the present disclosure when the tank closure is not placed in a closed position. The tank apparatus comprises an NVLD unit, which is configured to identify inadequate leak-tightness of the tank by monitoring a reduced pressure in the tank. The tank closure 2 comprises a sealing element 3 which extends around the opening of a filling nozzle 1 and which, when a tank closure 2 is in a closed position on the filling nozzle 1, seals with respect to the filling nozzle 1.

In accordance with the present disclosure, the tank closure 2 comprises a spacing element 4. The spacing element 4 is operable such that, when the tank closure 2 is placed on the filling nozzle 1 and is not in a closed position, bears on the filling nozzle 1. Thereby preventing contact of the sealing element 3 with the filling nozzle 1. In that way, the sealing element 3 is not drawn by a reduced pressure in the tank against the filling nozzle 1, and therefore, does not seal with respect to the filling nozzle 1. This is illustrated in FIG. 3 and in particular in the region B which shows the lack of support of the sealing element 3 on the filling nozzle 1, that is to say, on the shoulder 6 of the filling nozzle 1.

The spacing element 4 or more, for example, two spacing elements 4, are arranged radially outside the sealing element 3 on the tank closure 2. The spacing element 4 is a resilient element, against the force of which, when the tank closure 2 is in a closed position on the filling nozzle 1, the sealing element 3 is brought into contact with the filling nozzle 1. The in a closed position state of the tank apparatus from FIG. 3 is illustrated in FIG. 4. The tank closure 2 and/or the filling nozzle 1 has a thread 5 so that the tank closure 2 can be in a closed position by being screwed on the filling nozzle 1.

The spacing element 4, that is to say resilient element, is formed from spring sheet steel and protrudes axially from the tank closure 2, in the direction towards the filling nozzle 1. The spacing element 4 has a curvature or bend radially outwards with respect to the opening of the filling nozzle 1 which, when the tank closure 2 is placed and is not in a closed position, rests on the shoulder 6 of the filling nozzle 1 (FIG. 3) and, when the tank closure 2 axially approaches in the direction towards the filling nozzle 1 a formation, that is to say the shoulder 6 of the filling nozzle 1, carries out a movement of the spacing element 4 radially outwards. As a result of the fact that the spacing element 4, when the tank closure 2 is in a closed position, via a thread 5 is displaced outwards counter to the resilient force thereof and slides from the shoulder 6 of the filling nozzle 1—in the region C of FIG. 3—the sealing element 3 can rest on the shoulder 6 and/or on other portions of the filling nozzle 1 and seal (FIG. 4).

Consequently, the spacing element 4, when a tank closure 2 is placed on the filling nozzle 1 and is not in a closed position, bears on the filling nozzle 1 in such a manner on a shoulder 6 of the filling nozzle 1 that the spacing element 4, when the tank closure 2 is in a closed position, is pressed radially outwards with respect to the opening of the filling nozzle 1 so that the sealing element 3 comes into contact with the filling nozzle 1 and seals with respect to the filling nozzle 1.

The tank closure 2 may comprise a plurality of spacing elements 4, preferably resilient elements, which, when the tank closure 2 is placed, are arranged circumferentially around the opening of the filling nozzle 1 on the tank closure 2 and are located on the filling nozzle 1 when the tank closure 2 is positioned, that is to say, at least two spacing elements 4.

The sealing element 3 is an annular seal which extends around the opening of the filling nozzle 1 when the tank closure 2 is placed. The sealing element 3 may, for example, have a U-shaped profile.

### List of Reference Symbols

1, 10 Filling nozzle

2, 12 Tank closure

3, 13 Sealing element

4 Spacing element

5, 15 Thread

6, 16 Shoulder

7, 17 Vacuum

8, 18 Ambient pressure

A Region

B Region

C Region

What is claimed is:

1. A tank apparatus for a motor vehicle, the tank apparatus comprising:
a tank having a filling nozzle for filling the tank;
a vacuum leak detection unit configured to identify inadequate leak-tightness of the tank by monitoring a reduced pressure in the tank; and
a tank closure for placement on the filling nozzle between an unclosed position and a closed position, the tank closure including:
a sealing element which forms a seal with respect to the filling nozzle when the tank closure is in the closed position, and
a spacing element which engages the filling nozzle when the tank closure is in the unclosed position to thereby prevent contact of the sealing element with the filling nozzle.

2. The tank apparatus of claim 1, wherein the spacing element comprises a resilient element against a force of which the sealing element is brought into contact with the filling nozzle when the tank closure is in the closed position.

3. The tank apparatus of claim 1, wherein the tank closure and/or the filling nozzle has a thread to enable placement of the tank closure in the closed position by screw attachment.

4. The tank apparatus of claim 1, wherein the tank closure comprises a plurality of spacing elements are arranged circumferentially around the opening of the filling nozzle on the tank closure when the tank closure is in the closed position.

5. The tank apparatus of claim 1, wherein the spacing element comprises a resilient element formed from spring sheet steel.

6. The tank apparatus of claim 1, wherein the spacing element protrudes from the tank closure in the direction towards the filling nozzle.

7. The tank apparatus of claim 6, wherein the spacing element has a curvature oriented radially outward with respect to an opening of the filling nozzle.

8. The tank apparatus of claim 7, wherein the curvature of the spacing element causes movement of the spacing element radially outward when the tank closure axially approaches a shoulder of the filling nozzle in a direction towards the filling nozzle.

9. The tank apparatus of claim 1, wherein the spacing element is configured to engage, when the tank closure is placed on the filling nozzle in the unclosed position, the filling nozzle on a shoulder of the filling nozzle in such a manner that the spacing element, when the tank closure is in the closed position, is pressed radially outwards with respect to an opening of the filling nozzle to cause contact of the sealing element with the filling nozzle and form a seal with respect to the filling nozzle.

10. The tank apparatus of claim 1, wherein the sealing element comprises an annular seal which extends around the opening of the filling nozzle when the tank closure is placed in the closed position.

11. The tank apparatus of claim 1, wherein the tank apparatus comprises no additional sealing element which forms a seal between the tank closure and the filling nozzle.

12. The tank apparatus of claim 1, wherein the tank apparatus comprises one or more additional sealing elements configured to form a seal with respect to the filling nozzle when the tank closure is in the closed position.

13. The tank apparatus of claim 12, wherein the one or more additional sealing elements are configured to not form a seal between the tank closure and the filling nozzle when the tank closure is in the unclosed position so that there is no leak-tightness between the tank closure and the filling nozzle.

14. A tank apparatus for a motor vehicle, the tank apparatus comprising:
a tank having a filling nozzle for filling the tank;
a vacuum leak detection unit configured to identify inadequate leak-tightness of the tank by monitoring a reduced pressure in the tank; and
a tank closure for placement on the filling nozzle between an unclosed position and a closed position, the tank closure including a plurality of spacing elements which arranged circumferentially around an opening of the filling nozzle when the tank closure is in the closed position to engage the filling nozzle when the tank closure is in the unclosed position.

15. The tank apparatus of claim 14, further comprising a sealing element which forms a seal with respect to the filling nozzle when the tank closure is in the closed position.

16. The tank apparatus of claim 15, wherein the plurality of spacing elements comprise resilient elements formed from spring sheet steel against a force of which the sealing element is brought into contact with the filling nozzle when the tank closure is in the closed position.

17. The tank apparatus of claim 14, wherein the plurality of spacing elements have a curvature oriented radially outward with respect to the opening of the filling nozzle.

18. The tank apparatus of claim 17, wherein the curvature causes movement of the plurality of spacing elements radially outward when the tank closure axially approaches a shoulder of the filling nozzle in a direction towards the filling nozzle.

19. The tank apparatus of claim 14, wherein the spacing element is configured to engage, when the tank closure is placed on the filling nozzle in the unclosed position, the filling nozzle on a shoulder of the filling nozzle in such a manner that the spacing element, when the tank closure is in the closed position, is pressed radially outwards with respect to an opening of the filling nozzle to cause contact of the sealing element with the filling nozzle and form a seal with respect to the filling nozzle.
